(19) United States
(12) Patent Application Publication
(10) Pub. No.: US 2009/0121207 A1
(43) Pub. Date: May 14, 2009

(54) CONFIGURABLE ENCLOSURE

(76) Inventor: James Patrick Bowerman, New York, NY (US)

Correspondence Address: CANTOR COLBURN, LLP, 20 Church Street, 22nd Floor, Hartford, CT, 06103, US

(21) Appl. No.: 11/939,994

(22) Filed: Nov. 14, 2007

(51) Int. Cl. E04H 4/10; E04B 1/344; E06B 3/30; E06B 9/24

(52) U.S. Cl. 256/25; 160/352; 160/380; 160/383; 4/498; 52/63

(57) ABSTRACT

Disclosed is an enclosure for a water containing body, the enclosure including a frame configurable between multiple frame positions, a connective material associated with the frame, wherein the connective material is configurable into multiple connective material positions, and at least one association structure configured to moveably associate at least a portion of the frame with the water containing body.

### FIELD OF THE INVENTION

The disclosure relates generally to a configurable enclosure, and more particularly to a configurable enclosure for a water containing body or recreational structure.

### BACKGROUND OF THE INVENTION

For centuries (if not longer) people have enjoyed the use of pools or pool-like structures for recreational activities. Some of these recreational activates simply include swimming or floating in the pool. Others include pool sports, such as various forms of basketball, volleyball, and water polo. These sports offer a fun and refreshing activity, especially in hot weather climates and during hot weather seasons.

However, as these sports typically involve a moving ball of some kind, there is a substantial likelihood that the moving ball will likely be ejected from the pool at some point during the sport being played. It can be frustrating for the sport participants to have retrieve the ball when this happens, because in order to do so, one of the participants will have to leave the pool. Leaving of the pool to retrieve a ball not only delays the game, but can also force the wet participant who left the pool into a physically uncomfortable environment, which may include dirt and grass that will stick to his wet extremities. Upon the participant's return to the pool, this dirt and grass enters the pool with the re-entering participant, making for undesirable pool conditions.

One means of remedying occurrences of ball ejection from a pool involves enclosing the pool with some sort of pool structure. However, pool enclosures can include multiple shapes and dimensions. Because different pool sports involve different and various ball trajectories, some enclosure shapes/dimensions can be more suitable to some games than others. Accordingly, it would be desirable to a pool sport participant to be able to employ a pool enclosure that could be used to contain balls that are projected at different trajectories depending on the sport being played.

### SUMMARY OF THE INVENTION

Disclosed is an enclosure for a water containing body, the enclosure including a frame configurable between multiple frame positions, a connective material associated with the frame, wherein the connective material is configurable into multiple connective material positions, and at least one association structure configured to moveably associate at least a portion of the frame with the water containing body.

Also disclosed is an enclosable pool including a pool structure configured to contain a desired amount of water, a frame configurable between a first frame position and a second frame position; at least a portion of the frame being moveably associated with the pool structure via at least one association structure, and a flexible connective material associated with the frame, wherein said connective material is configurable into a first connective material position when the frame is in the first frame position, and wherein the connective material is configurable into a second connective material position when the frame is in the second frame position.

Further disclosed is an enclosure for a recreational structure, the enclosure including a frame configurable between multiple frame positions, a flexible connective material associated with the frame, wherein the connective material is configurable into multiple connective material positions, and at least one association structure configured to moveably associate at least a portion of the frame with the recreational structure.

### BRIEF DESCRIPTION OF THE FIGURES

The following descriptions should not be considered limiting in any way. With reference to the accompanying drawings, like elements are numbered alike:

FIG. 1 is a side perspective view of a configurable enclosure in a first position;

FIG. 2 is a side perspective view of the configurable enclosure in a second position;

FIG. 3 is a schematic view of a hinge structure for use with the configurable enclosure;

FIG. 4 is an elevated view of the configurable enclosure in the first position;

FIG. 5 is a plan view of the configurable enclosure in the first position;

FIG. 6 is an elevated view of a configurable enclosure in accordance with a second embodiment;

FIG. 7 is another elevated view of the configurable enclosure in accordance with the second embodiment;

FIG. 8 is an elevated view of a configurable enclosure in accordance with a second embodiment, the enclosure being in a first position; and

FIG. 9 is an elevated view of a configurable enclosure in accordance with the third embodiment, the enclosure being in a second position.

### DETAILED DESCRIPTION

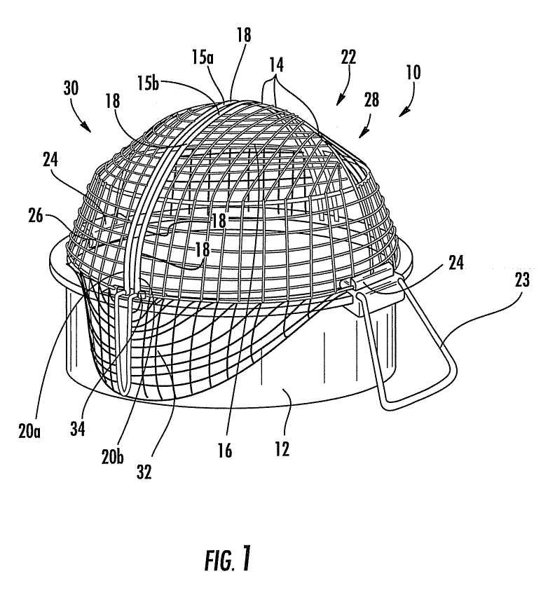

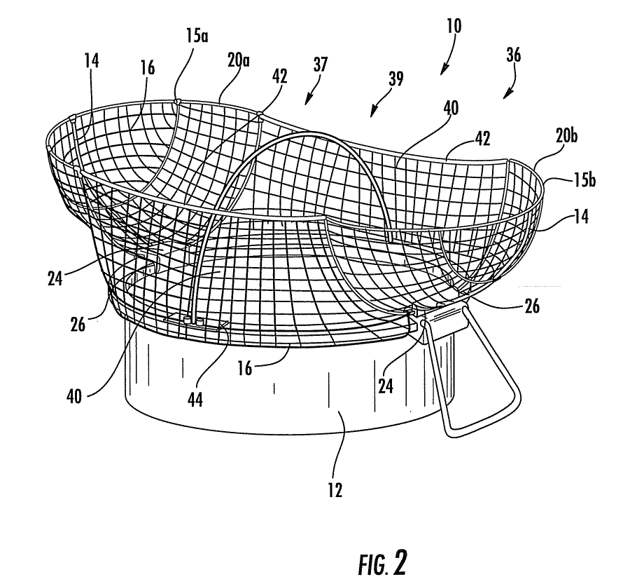

Referring to FIGS. 1 and 2, an exemplary embodiment of a configurable enclosure 10 for a water containing body 12 is illustrated. In this exemplary embodiment, the water containing body 12 is an above ground pool. The enclosure 10 includes a relatively rigid frame 14, which itself includes a first portion 15a and a second portion 15b. The enclosure 10 also includes a relatively flexible connective material 16 (relative to the frame 14) that is fixed to the frame 14 at various points (some of these points being represented in the Figures at connection points 18) along the frame. A concentration of connecting points 18 are found at primary arch portions 20a and 20b of the frame portions 15a and 15b.

Referring now to FIG. 1 in particular, the frame portions 15a and 15b are shown in a first frame position 22. In the exemplary embodiment of FIG. 1, each frame portion 15a and 15b is associated with the pool 12 via a hinge structure 24 disposed at substantially opposite ends of the pool structure 12. These hinge structures 24 may be fixed to the pool structure 12 via any mechanical or adhesive means (including Velcro), as well as being of unitary construction with the pool structure 12. The hinge structures 24 may also be associated with support structures 23 that extend from the hinges 24 to the ground around the pool 12. These support structures provide support to the enclosure 10 during any vibrations of the enclosure 10 during pool activities.

In addition to associating the frame 14 with the pool structure 12, the hinge structures 24 also create an axis point 26 for each frame portion 15a and 15b. These axis points 26 allow the frame portions 15a and 15b to rotate about their association with the pool 12. The hinge structures 24 may additionally be configured to releasably lock the frame portions 15a and 15b in the first frame position 22. This releasable locking may be accomplished via any known mechanism, including but not limited to a pin insertable hinge 24, as shown in FIG. 3. In this pin insertable hinge embodiment, a pin 25 may be inserted through openings 27 defined by the hinge 24 and openings 29 defined by the portion 31 of the frame portion 15a or 15b contained by the hinge 24. Insertion of the pin 25 through the openings 27 and 29 locks the frame portion 15a or 15b into the first frame position 22. More on rotation about the hinges 24 and axis points 26 will be discussed with reference to FIG. 2 later in the disclosure.

When the frame portions 15a and 15b are in the first frame position 22 as shown in FIG. 1, the connective material 16 is configured by the frame portions 15a and 15b into a first connective material position 28. When the frame portions 15a and 15b and connective material 16 are configured into their respective first positions 22 and 28, the enclosure 10 essentially forms a dome 30 over the pool 12. It should be noted that when the connective material 16 is in the first connective material position 28, there may be an amount of slack material 32 that hangs off of the frame 14. In the exemplary embodiment of FIGS. 1 and 2, at least a portion of this slack material 32 is associated with the pool structure 12 (as will be discussed in greater detail below).

As is also shown in FIG. 1, the structure of the dome 30 can be reinforced by releasably latching the frame portions 15a and 15b to each other, or the pool structure 12. The latching in the embodiment of FIG. 1 is accomplished via latch structures 34 attached to the pool structure 12. These latch structures 34 essentially allow the frame portions 15a and 15b to releasably hook into association with the pool 12 when the frame portions 15a and 15b are disposed in the first frame position 22. It should be appreciated that when the enclosure is configured into the dome configuration 30 (via a configuring of the frame portions 15a and 15b and connective material 16 into their respective first positions 22 and 28), the connective material 16 and frame 14 include a weight, strength, and association with each other and the pool 12 that is strong enough form a barrier sufficient for preventing the balls used in various sports from leaving the inside of the dome 30.

Upon an unlocking of the hinge structures 24 (i.e. a removal of the pin 25 in the exemplary embodiment of FIG. 3), the frame portions 15a and 15b are freed to rotate about the axis points 26. Referring to FIG. 2, the frame portions 15a and 15b have been rotated about the axis points 26 into a second frame position 36. Once in the second frame position 36, the hinge structures 24 may be releasably locked to hold the frame 14 in the second position 36. This locking may again be accomplished via any known releasably lockable mechanism, such as but not limited to the pin insertable hinge 24 of FIG. 3. When in the second frame position 36, the portion 31 and openings 29 are rotated approximately 90 degrees from the locking point of the first frame position 22. The pin 25 is inserted through the openings 29 via second position openings 38 of the hinge 24, holding the frame portions 15a and 15b in the second frame position 36.

As shown in FIG. 2, when the frame portions 15a and 15b are in the second frame position 36, the connective material 16 is configured by the frame portions 15a and 15b into a second connective material position 39. When the frame portions 15a and 15b and connective material 16 are configured into their respective second positions 36 and 39, the enclosure 10 essentially forms an open stadium configuration 37 around the pool 12. The configuring of the connective material 16 into the second connective material position 39 forms this stadium configuration by stretching the slack material 32 of FIG. 1 into taut material 40. In the exemplary embodiment of FIG. 2, the tautness of this material 40 is most clearly demonstrated at connective bands 42. When taut, as shown in FIG. 2, these bands can hold the frame portions 15a and 15b from rotating any further away from each other without the aid of a locked hinge 24.

At relative bottom portions 44 of the taut material 40 (opposite the bands 42), the connective material 16 may associate with the pool structure 12 so as to strengthen tautness of the material 40. This bottom portion 44 may associate with the pool structure via any means desirable, such as but not limited to a plurality of hooks and Velcro. In the exemplary embodiment of FIG. 2, the association between the bottom portion 44 and pool structure 12 takes place at an underside of a rim 46 that runs around the pool structure 12. It should be appreciated that when the enclosure is configured into the stadium configuration 37 (via a configuring of the frame portions 15a and 15b and connective material 16 into their respective second positions 36 and 39), the taut material 40 is stretched tight enough to form a barrier that prevents the balls used in various sports from leaving the sides of the pool 12. This sufficient tautness may be accomplished with or without the aid of an association between the bottom portions 44 and the pool structure 12.

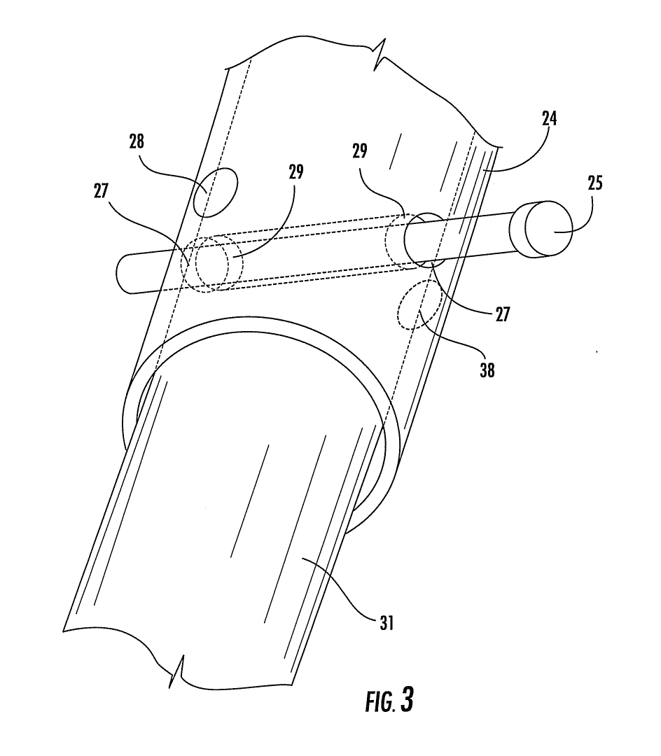

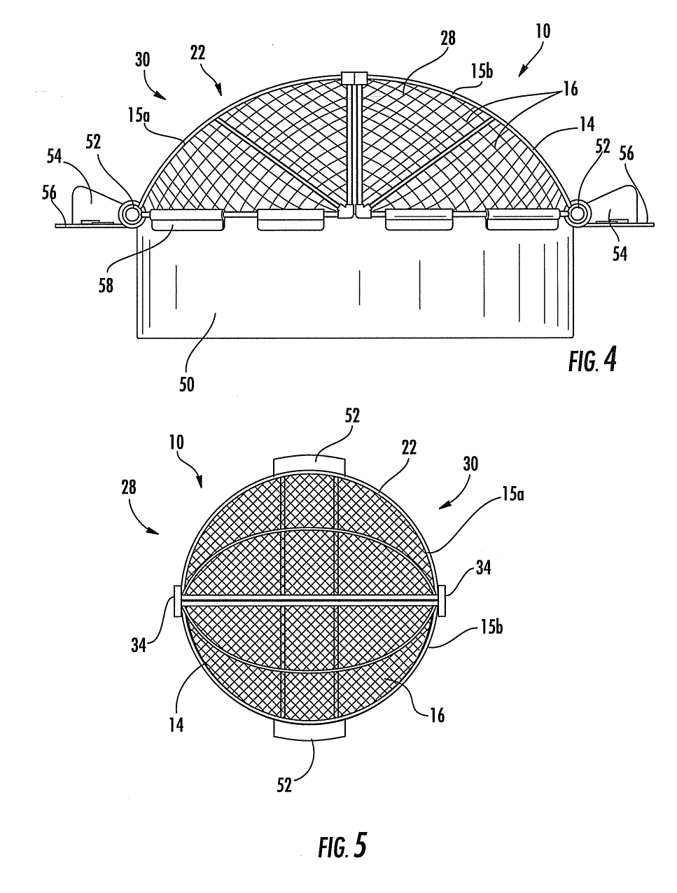

Referring now to FIGS. 4 and 5, the enclosure 10 is also usable with an in-ground pool 50. As above, in the exemplary embodiments of these Figures, the frame 14 and connective material 16 of the enclosure 12 are configurable between respective first 22 and 28 and second 36 and 39 positions, so as to achieve the dome configuration 30 of FIG. 1 and the stadium configuration 37 of FIG. 2. Configuration between these positions may be accomplished in the same manner as discussed with regards to FIGS. 1-3. However, when used with the in-ground pool 50, the enclosure 10 may be configured with some different and/or additional features than those used with the above ground pool 12. These features will be discussed hereinbelow.

One such feature involves hinge structures 52, as shown in FIGS. 4 and 5. While these hinge structures 52 function similarly to the hinge structures 24 discussed above, they comprise a weighted body 54, which helps to anchor the enclosure 10 to a surface 56 that surrounds the in-ground pool 50. In the exemplary embodiment of the Figures, the hinges are (like above) located at substantially opposite ends of the pool 50. The weighted bodies 54 may be hollow containers filled with weight providing elements such as but not limited to water, sand, and rocks.

FIGS. 4 and 5 also illustrate floatation devices 58 in association bottom portions 60 of the frame portions 15a and 15b. These floatation devices 58 are illustrated with the in-ground pool 50, but are usable in any water containing structure, including an above ground pool, such as the pool 12 of FIGS. 1-2. The floatation devices 58 allow any portions of the enclosure 10 disposed away from the sides of the pool 50 to float upon the water in the pool. This is a particularly advantageous feature when the enclosure 10 is being used with a water containing structure that includes a rectangular, square, oval, or irregular shape (irregular meaning anything that is not square, rectangular, oval, or circular). Floatation devices may also be disposed along the bottom portions 44 of the slack/taut material 32 and 40.

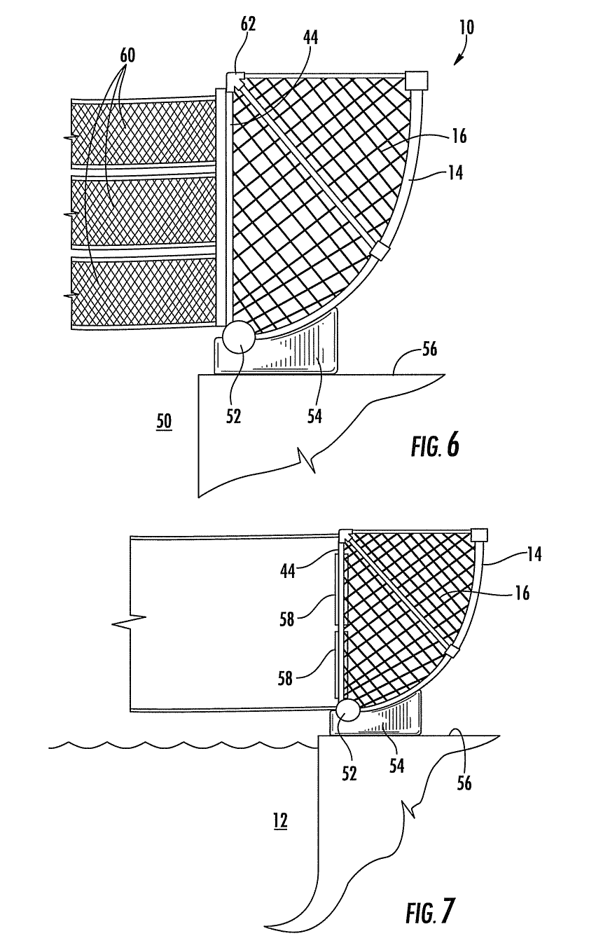

Referring now to FIGS. 6-7, it should also be appreciated that the enclosure 10 may be employed without slack material 32. In the embodiment of these Figures, slack material 32 is replaced by connective material extensions 60 that are removably fixed to the bottom portions 44 of the frame portions 15a and 15b. These extensions 60 may simply be strips of connective material 16 associated with and extended between the bottom portions 44 of frame portions 15a and 15b when the frame portions 15a and 15b are configured into the second position 36. The extensions 60 may associate with the bottom portions 44 via any means desirable, such as but not limited to a plurality of hooks or Velcro. In addition, these extensions 60 may be contained automatically retractable, spring-loaded enclosures 62 that are removably or permanently attached to the bottom portions 44 of the frame portions 15a and 15b.

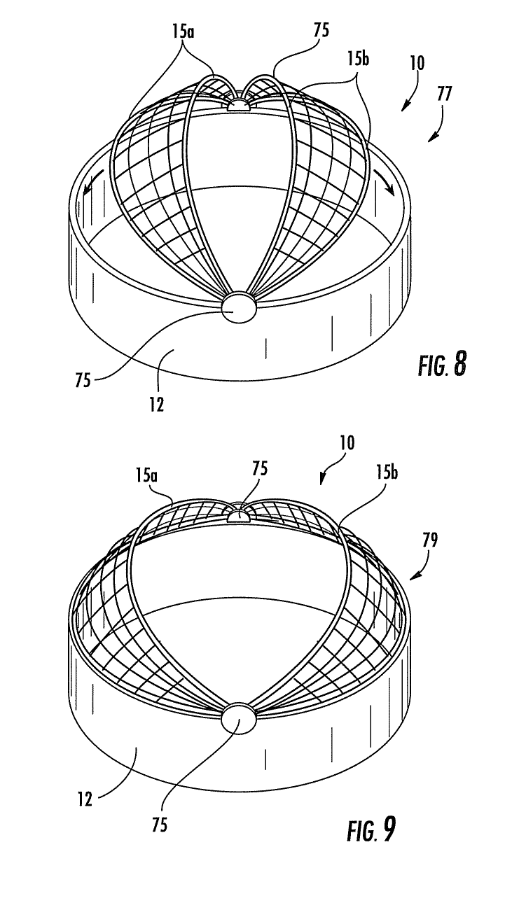

Referring now to FIGS. 8 and 9, it should be appreciated that the enclosure 10 may be configured to include hinge structures 75, wherein each hinge structure rotateably associates an end of each frame portion 15a and 15b to the pool structure 12. This configuration allows the enclosure 10 to be configured between the closed position 77 shown in FIG. 8 and the open position 79 shown in FIG. 9.

It should also be appreciated that the enclosure 10 (as configured in any of the above discussed Figures) may be used with recreational structures other than the water containing bodies discussed above. One such recreational structure is a trampoline. The enclosure may associate with a trampoline, or other recreational structures, in the same manner as discussed with reference to the water containing bodies discussed above.

Referring now to the embodiments of all of the FIGS. 1-8, it should be appreciated that the materials of the frame 14 and connective material may be any material desirable to use with the enclosure 10. With regards to the frame 14, this material may partially or fully comprise the frame 14, and may be any material such as but not limited to hard plastic, inflatable plastic, rubber, or rubber/plastic coated metal. With regards to the connective material 16, this material may partially or fully comprise the connective material 16, and may be any material such as but not limited to plastic netting or mesh, rubber netting or mesh, a flexible rubber/plastic sheet, a flexible rubber/plastic coated chain-link fencing, or rope netting or mesh. Depending on the presence/size of the openings formed by the connective material, the dome configuration 30 of the enclosure 10 may be useful as a pool cover for preventing debris from falling into the pool 12 or 50 when the pool is or is not in use.

It should also be appreciated that any of the above discussed embodiments may be used with a water containing structure of any size or shape, including naturally occurring bodies of water such as lakes, ponds, rivers, and oceans. When used on naturally occurring bodies of water or over-sized pools, the enclosure 10 may be configured to float entirely on a body of water with minimal or no connection to a solid structure. The floatation devices (like devices 58) discussed above, a floatable frame, and/or floatable hinges could be used to allow for a floating enclosure.

It should be further appreciated that the frame 14 and connective material 16 of any of the above discussed embodiments may be configured to associate and interact with any sport accessories desirable to pool sports, such as but not limited to basketball hoops, volleyball nets, and water polo goals. In addition the connective material 16 and/or frame 14 may be equipped with a break away region for easy entry or exit to of from the confines of the enclosure 10. These break away regions may employ a body sized opening (at least body sized) covered by connective material 16 attached to the perimeter of the opening via Velcro.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

What is claimed is:

1. An enclosure for a water containing body, the enclosure comprising:
a frame configurable between multiple frame positions;
a connective material associated with said frame, wherein said connective material is configurable into multiple connective material positions; and
at least one association structure configured to moveably associate at least a portion of said frame with the water containing body.

2. The enclosure of claim 1, wherein said multiple frame positions are a first frame position and a second frame position and said multiple connective material positions are a first connective material position and a second connective material position, wherein said connective material is configurable into said first connective material position when said frame is in said first frame position, and wherein said connective material is configurable into said second connective material position when said frame is in said second frame position.

3. The enclosure of claim 2, wherein said frame includes at least a first portion and a second portion, and said at least one association structure are a first lockable hinge and a second lockable hinge disposed at substantially opposite ends of the water containing body, said first lockable hinge being configured to rotateably associate at least said first portion with the water containing body and said second lockable hinge being configured to rotateably associate at least said second portion with the water containing body.

4. The enclosure of claim 3, wherein said first portion and said second portion are releasably latchable to at least one of the water containing body and each other when said frame is in said first frame position.

5. The enclosure of claim 3, wherein said flexible connective material associates said first portion and said second portion, said flexible connective material including an amount of slack material between said first portion and said second portion.

6. The enclosure of claim 5, wherein enough of said slack material is provided to allow said first portion and said second portion to rotate a desired distance from each other about a first axis at said first lockable hinge and a second axis at said second lockable hinge.

7. The enclosure of claim 6, wherein said frame is disposed in said second frame position and said connective material is disposed in said second connective material position when said first portion and said second portion are rotated away from each other to said desired distance.

8. The enclosure of claim 4, wherein said flexible connective material and said frame are configured into a substantially enclosed dome configuration when said first portion and said second portion are latched to at least one of each other and the water containing body in said first frame position and said first connective material position.

9. The enclosure of claim 7, wherein said flexible connective material and said frame are configured into an open configuration when said first portion and said second portion are at said desired distance from each other in said second frame position and in said second connective material position, wherein said connective material and said frame define an enclosure opening when in said open configuration.

10. The enclosure of claim 9, wherein a portion of said slack material is attachable to said water containing body via at least one attachment structure.

11. The enclosure of claim 3, wherein said connective material is strips of connective material associable with said first frame portion and said second frame portion and extendable between said first frame portion and said second frame portion when said first frame portion and said second frame portion are configured into said second frame position, wherein said strips are containable in automatically retractable, spring-loaded enclosures that are removably associable with bottom portions of at least one of said first frame portion and said second frame portion.

12. An enclosable pool comprising:
a pool structure configured to contain a desired amount of water;
a frame configurable between a first frame position and a second frame position; at least a portion of said frame being moveably associated with said pool structure via at least one association structure; and
a flexible connective material associated with said frame, wherein said connective material is configurable into a first connective material position when said frame is in said first frame position, and wherein said connective material is configurable into a second connective material position when said frame is in said second frame position.

13. The enclosable pool of claim 12, wherein said pool structure includes a shape that is at least one of circular, oval, elliptical, square, rectangular, and irregular, and wherein said pool structure defines at least one of an in-ground pool and an above-ground pool.

14. The enclosure of claim 12, wherein said frame includes a first portion and a second portion, and said at least one association structure are a first lockable hinge and a second lockable hinge disposed at substantially opposite ends of the pool, said first lockable hinge being configured to rotateably associate at least said first portion with the pool structure and said second lockable hinge being configured to rotateably associate at least said second portion with the pool structure.

15. The enclosure of claim 14, wherein said first portion and said second portion are releasably latchable to at least one of the pool and each other when said frame is in said first frame position, and wherein said flexible connective material associates said first portion and said second portion, said flexible connective material including an amount of slack material between said first portion and said second portion.

16. The enclosure of claim 15, wherein enough of said slack material is provided to allow said first portion and said second portion to rotate a desired distance from each other at a first axis at said first lockable hinge and a second axis at said second lockable hinge.

17. The enclosure of claim 16, wherein said frame is disposed in said second frame position and said connective material is disposed in said second connective material position when said first portion and said second portion are rotated away from each other to said desired distance.

18. The enclosure of claim 14, wherein said flexible connective material and said frame are configured into a substantially enclosed dome configuration when said first portion and said second portion are latched to at least one of each other and the pool structure in said first frame position and said first connective material position.

19. The enclosure of claim 17, wherein said flexible connective material and said frame are configured into an open configuration when said first portion and said second portion are at said desired distance from each other in said second frame position and in said second connective material position, wherein said connective material and said frame define an enclosure opening when in said open configuration.

20. An enclosure for a recreational structure, the enclosure comprising:
a frame configurable between multiple frame positions;
a flexible connective material associated with said frame, wherein said connective material is configurable into multiple connective material positions; and
at least one association structure configured to moveably associate at least a portion of said frame with the recreational structure.
